(19) United States
(12) Patent Application Publication
(10) Pub. No.: US 2020/0236931 A1
(43) Pub. Date: Jul. 30, 2020

(54) ANTIMICROBIAL ARTICLES

(71) Applicant: 1/1 COVIDIEN LP, Mansfield, MA (US)

(72) Inventors: Kevin P. Trainor, Greenville, RI (US); Valentino J. Tramontano, Brockton, MA (US)

(21) Appl. No.: 16/636,728

(22) PCT Filed: Nov. 21, 2018
(86) PCT No.: PCT/US2018/062218

§ 371 Date: Feb. 5, 2020

Related U.S. Application Data
(60) Provisional application No. 62/589,687, filed on Nov. 22, 2017.

(51) Int. Cl. A01N 25/34; A01N 25/10; A01N 47/44; A01N 55/02

(52) U.S. Cl. CPC A01N 25/34; A01N 55/02; A01N 47/44; A01N 25/10

(57) ABSTRACT

Antimicrobial films and processes therefor are described. In some examples, the films include at least one water permeable polymer including uniformly dispersed particles of at least one antimicrobial agent having an average size of no greater than 50 microns. The antimicrobial film defines a contact surface configured to contact a target surface of a separate article to provide an antimicrobial effect to the target surface.

### TECHNICAL FIELD

The present disclosure relates to, in some examples, antimicrobial articles.

### BACKGROUND

Various surfaces host microbial populations, for example, one or more species of bacteria. Such microbial populations can spread by contact with the surfaces. For example, bacteria or bacterial spores may be spread or transferred from an originating surface to another surface by physical contact such as touching, swiping, wiping, or brushing.

Implantable medical devices used for patient treatment can be a source of microbial infection in such patients. For example, insertion or implantation of a medical device into a patient can introduce microbes from surfaces or from interiors of implantable medical devices, causing infection. To reduce or minimize the impact of the introduction of microbes to a patient, many medical devices, such as catheters, have been coated with antimicrobial agents.

However, many antimicrobial agents that are useful in coating medical devices tend to be insoluble in formulations used to coat the device and may not reduce microbial colonization of microorganisms that are the source of a bacterial infection.

### SUMMARY

In some examples, the disclosure describes an antimicrobial film and an example article including an antimicrobial film. The antimicrobial film includes at least one water permeable polymer including uniformly dispersed particles of at least one antimicrobial agent. The particles and any agglomerations of the antimicrobial agent have an average size of no greater than 50 microns. The antimicrobial film defines a contact surface configured to contact a target surface of a second article to provide an antimicrobial effect to the target surface.

In some examples, the disclosure describes an example technique including milling at least one water permeable polymer which is dissolved in a liquid medium with at least one antimicrobial agent which is insoluble in the liquid medium to form an antimicrobial formulation. In the antimicrobial formulation, the at least one water permeable polymer encapsulates the at least one antimicrobial agent. The example technique includes adding a primary C₁₋₆ alcohol to the antimicrobial formulation. The at least one antimicrobial agent includes a silver-based antimicrobial agent. The at least one water permeable polymer includes at least one of a polyurethane or a thermoplastic polyurethane elastomer. The example technique includes forming the antimicrobial formulation into an antimicrobial film. Following the forming of the antimicrobial film, the antimicrobial film defines a contact surface configured to contact a target surface of a separate article to provide an antimicrobial effect to the target surface.

In some examples, the disclosure describes an example technique including applying an antimicrobial film on a target surface defined by a separate article to provide an antimicrobial effect to the target surface. The antimicrobial film includes at least one water permeable polymer and uniformly dispersed particles therein of at least one antimicrobial agent. The particles and any agglomerations of the antimicrobial agent have an average size of no greater than 50 microns. The antimicrobial film defines a contact surface configured to contact the target surface.

Clause 1: An article comprising an antimicrobial film, wherein the antimicrobial film comprises at least one water permeable polymer comprising uniformly dispersed particles of at least one antimicrobial agent, wherein the particles and any agglomerations of the at least one antimicrobial agent have an average size of no greater than 50 microns, wherein the antimicrobial film defines a contact surface configured to contact a target surface defined by a second article to provide an antimicrobial effect to the target surface.

Clause 2: The article of clause 1, wherein the contact surface comprises one or more of a tacky surface, an adhesive surface, or an electrostatic surface.

Clause 3: The article of clauses 1 or 2, further comprising a release liner, wherein the contact surface is in releasable contact with the release liner.

Clause 4: The article of any of clauses 1 to 3, wherein the antimicrobial film defines a roll.

Clause 5: The article of clause 4, further comprising a core, and wherein the roll is wound about the core.

Clause 6: The article of any of clauses 1 to 5, wherein the antimicrobial film defines a sheet or a strip.

Clause 7: The article of any of clauses 1 to 6, further comprising a surgical tray defining a holding surface, wherein the holding surface defines the target surface, wherein the antimicrobial film is in contact with the target surface.

Clause 8: The article of any of clauses 1 to 7, wherein the average size is no greater than 20 microns.

Clause 9: The article of any of clauses 1 to 8, wherein the at least one water permeable polymer encapsulates the at least one antimicrobial agent.

Clause 10: The article of any of clauses 1 to 9, wherein the at least one water permeable polymer includes at least one of a polyurethane or a thermoplastic polyurethane elastomer.

Clause 11: The article of any of clauses 1 to 10, wherein the at least one water permeable polymer includes at least one of a polyurethane, thermoplastic polyurethane elastomer, polyester, polylactic acid, polyglycolic acid, polytetramethylene glycol, polyacrylamide, polyacrylic acid, polyacrylate, poly(2-hydroxyethyl methacrylate), polyethylene-imine, poly-sulfonate, or copolymers thereof.

Clause 12: The article of any of clauses 1 to 11, wherein the at least one water permeable polymer has a weight average molecular weight of from about 70,000 to about 120,000 Daltons.

Clause 13: The article of any of clauses 1 to 12, wherein the at least one antimicrobial agent comprises silver sulfadiazine, and wherein the antimicrobial film has a release profile such that at least 0.50 micrograms per centimeter (μg/cm) of silver is continuously released after 72 hours.

Clause 14: The article of any of clauses 1 to 13, wherein the at least one antimicrobial agent comprises chlorhexidine diacetate, and wherein the antimicrobial film has a release profile such that at least 10 μg/cm of chlorhexidine diacetate is continuously released after 72 hours.

Clause 15: The article of any of clauses 1 to 14, wherein the at least one antimicrobial agent comprises a silver-based salt and a polybiguanide salt.

Clause 16: The article of clause 15, wherein the silver-based salt is silver sulfadiazine, and the polybiguanide salt is chlorhexidine diacetate.

Clause 17: The article of clause 16, wherein the antimicrobial film comprises from about 2 weight percent (wt. %) to about 10 wt. % of silver sulfadiazine, at least 9 wt. % of chlorhexidine diacetate, and about 70 wt. % to about 90 wt. % of the at least one water permeable polymer.

Clause 18: The article of clause 17, wherein the antimicrobial film has a release profile such that at least 0.50 μg/cm of silver is continuously released after 150 hours.

Clause 19: The article of clause 17, wherein the antimicrobial film has a release profile such that at least 10 μg/cm of chlorhexidine diacetate is continuously released after about 150 hours.

Clause 20: The article of any of clauses 1 to 19, wherein the antimicrobial film defines a thickness of about 5 microns and about 1000 microns.

Clause 21: The article of any of clauses 1 to 20 and further comprising the second article defining the target surface, wherein the contact surface of the antimicrobial film is in contact with the target surface, wherein the second article comprises at least one of a surgical tray, an operating table, an operating console, an implantable device, a medical device, a medical tool, a catheter, a wound dressing, a securement dressing, a light emitting device, door, faucet, light switch, or keypad.

Clause 22: A method comprising applying the antimicrobial film of any of clauses 1 to 21 to the target surface defined by the second article by bringing the contact surface in contact with the target surface.

Clause 23: A method comprising: milling at least one water permeable polymer which is dissolved in a liquid medium with at least one antimicrobial agent which is insoluble in the liquid medium to form an antimicrobial formulation in which the at least one water permeable polymer encapsulates the at least one antimicrobial agent; adding a primary C₁₋₆ alcohol to the antimicrobial formulation, wherein the at least one antimicrobial agent includes a silver-based antimicrobial agent, and wherein the at least one water permeable polymer includes at least one of a polyurethane or a thermoplastic polyurethane elastomer; and forming an antimicrobial film from the antimicrobial formulation, wherein, following the forming of the antimicrobial film, the antimicrobial film defines a contact surface configured to contact a target surface defined by a separate article to provide an antimicrobial effect to the target surface.

Clause 24: The method of clause 23, wherein the antimicrobial formulation comprises uniformly dispersed particles of the at least one antimicrobial agent, wherein the particles and any agglomerations of the at least one antimicrobial agent have an average size of no greater than 50 microns.

Clause 25: The method of clauses 23 or 24, wherein the forming comprises: applying a curable coating of the antimicrobial formulation on a working substrate; allowing the coating to cure into the antimicrobial film formed on the working substrate; and removing the antimicrobial film from the working substrate.

Clause 26: The method of any of clauses 23 to 25, wherein the forming comprises extruding a sheet of the antimicrobial film.

Clause 27: The method of any of clauses 23 to 26, further comprising applying an adhesive composition to a major surface defined by the antimicrobial film.

Clause 28: The method of any of clauses 23 to 27, further comprising applying a release liner to the contact surface defined by the antimicrobial film.

Clause 29: The method of any of clauses 23 to 28, further comprising winding the antimicrobial film about a core to form a roll.

Clause 30. The method of any of clauses 23 to 29, wherein the at least one antimicrobial agent includes a combination of the silver-based antimicrobial agent and a polybiguanide or salt thereof.

Clause 31: The method of any of clauses 23 to 30, wherein the at least one antimicrobial agent includes a combination of silver sulfadiazine and chlorhexidine diacetate.

Clause 32: A method comprising applying an antimicrobial film on a target surface defined by a separate article to provide an antimicrobial effect to the target surface, wherein the antimicrobial film comprises at least one water permeable polymer and uniformly dispersed particles therein of at least one antimicrobial agent, wherein the particles and any agglomerations of the at least one antimicrobial agent have an average size of no greater than 50 microns, wherein the antimicrobial film defines a contact surface configured to contact the target surface.

Clause 33: An article comprising a plurality of antimicrobial fibers, wherein the plurality of antimicrobial fibers comprise at least one water permeable polymer comprising uniformly dispersed particles of at least one antimicrobial agent, wherein the particles and any agglomerations of the at least one antimicrobial agent have an average size of no greater than 50 microns.

Clause 34: The article of clause 33, wherein the plurality of fibers form a braided, woven, or nonwoven substrate.

Clause 35: The article of clause 33 or 34, wherein the article comprises at least one of a suture, a wound dressing, gauze, a hernia mesh, a glove, a sock, pants, a shirt, a surgical mask, a shoe cover, a hat, a hairnet, or a sterile field drape.

Clause 36: The article of any of clauses 1 to 21, wherein the target surface comprises a skin of a human patient.

Clause 36: The article of any of clauses 1 to 21, wherein the antimicrobial film is configured to be applied in direct contact with a skin of a human patient.

Clause 37: The method of any of clauses 22 to 32, wherein the antimicrobial film is configured to be applied in direct contact with a skin of a human patient.

Clause 38: The method of any of clauses 22 to 32, further comprising applying the antimicrobial film to skin of a human patient such that the antimicrobial film is in direct contact with the skin of the human patient.

Clause 39: The method of any of clauses 22 to 32, further comprising wrapping the antimicrobial film around a portion (e.g., a limb or a torso) of the patient.

Additional advantages of the present invention will become readily apparent to those skilled in this art from the following detailed description, wherein only examples according to the disclosure are shown and described. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent similar elements throughout and wherein:

FIG. 1A is a schematic and conceptual illustration of an assembly including an article including an antimicrobial film and a substrate separate from the antimicrobial film and defining a target surface.

FIG. 1B is a schematic and conceptual illustration of the assembly of FIG. 1A in which the antimicrobial film is applied to the target surface of the substrate.

FIG. 1C is a schematic and conceptual side view of the antimicrobial film of FIG. 1A including an adhesive layer.

FIG. 2A is a schematic and conceptual illustration of an assembly including an article including an antimicrobial film and a tray separate from the antimicrobial film and defining a target surface.

FIG. 2B is a schematic and conceptual illustration of the assembly of FIG. 2A in which the antimicrobial film is applied to the target surface of the tray.

FIG. 3 is a schematic and conceptual illustration of an article including an antimicrobial film and a release liner applied to a contact surface defined by the antimicrobial film.

FIG. 4 is a schematic and conceptual illustration of an article including an antimicrobial film defining a roll wound about a core.

FIG. 5 is a flow diagram illustrating an example technique for forming an antimicrobial film.

FIG. 6 is a photograph illustrating an example antimicrobial film.

FIG. 7 is a flow diagram illustrating an example technique for forming an article including antimicrobial fibers.

FIGS. 8 and 9 are scanning electron microscope (SEM) images of an example antimicrobial film in accordance with some examples of the disclosure.

FIGS. 10-12 are SEM images of an example antimicrobial fiber in accordance with some examples of the disclosure.

FIG. 13 is a diagram illustrating an example handle guard for an operating room lighting device, wherein the handle guard defines an example target surface onto which an example antimicrobial film may be applied.

The details of one or more aspects of the disclosure are set forth in the accompanying drawings and the description below. Other features, objects, and advantages of the techniques described in this disclosure will be apparent from the description and drawings, and from the claims.

### DETAILED DESCRIPTION OF THE DISCLOSURE

Unless defined otherwise, all technical and scientific terms used generally have the same meaning as commonly understood by one of ordinary skill in the art.

The articles “a” and “an” are used to refer to one or to over one (i.e., to at least one) of the grammatical object of the article. For example, “an element” means one element or over one element.

The term “at least” refers to no less than or at the minimum. For instance, “at least one” could be one or any numbers more than one.

In some examples, the term “contact surface” refers to a surface capable of temporarily or substantially permanently remaining in contact with or adhering to another surface, for example, for a predetermined period of time.

In some examples, the term “adhesive composition” refers to a composition including at least one agent that promotes adhesion between two predetermined surfaces

In some examples, the term “adhesive surface” refers to a surface on which an adhesive composition is applied.

In some examples, the term “agglomerations” refers to a bound or joined plurality of particles, individual particles of the plurality of particles retaining their identity.

In some examples, the term “antimicrobial agent” refers to an agent that kills or slows the growth of at least one type of microbial organism.

In some examples, the term “antimicrobial film” refers to a film including a polymeric matrix and antimicrobial agents dispersed in the polymeric matrix.

In some examples, the term “antimicrobial effect” refers to killing or slowing of the growth of at least one type of microbial organism.

In some examples, the term “average size” refers to a statistical average of a predetermined statistical population of sizes.

In some examples, the term “core” refers to a central substrate about which a roll may be wound.

In some examples, the term “curable” refers to a composition comprising polymerizable or cross-linkable components capable of being polymerized or cross-linked in response to predetermined polymerization or curing conditions.

In some examples, the term “curing” refers to polymerizing of monomeric components into polymeric components or formation of cross-links between monomeric or polymeric components of a composition.

In some examples, the term “drying” refers to active or passive removal of a solvent from a solution in ambient conditions, or in response to heat, or in response to a lowering of pressure, or in response to application of vacuum to the solution.

In some examples, the term “electrostatic surface” refers to a surface carrying or capable of carrying static electric charges and interacting with another charged surface. Oppositely charged surfaces may attract, contact, and adhere to one another.

In some examples, the term “encapsulation” refers to covering of substantially all exterior surfaces of a particle or an agglomeration of particles by a polymer.

In some examples, the term “extrusion” refers to forcing of a composition through a die having a predetermined cross-section to form an extruded article having a predetermined geometry. In some examples, extrusion may be performed through a heated die or on a heated composition.

In some examples, the term “fiber” refers to a thread or filament, e.g., from which a textile may be formed or from which a suture thread may be formed.

In some examples, the term “film” refers to a thin flexible free-standing sheet including a polymeric matrix defining opposed major surfaces.

In some examples, the term “forming” refers to creating a free-standing article, for example, a film defining two opposed major surfaces, from a volume of liquid formulation.

In some examples, the term “holding surface” refers to a surface capable of holding one or more articles, for example, under the influence of gravity.

In some examples, the term “milling” refers to reducing the size of material by exposing the material to recurring mechanical impact with milling media, for example, by grinding, crushing, or cutting.

In some examples, the term “primary C₁₋₆ alcohol” refers to an alcohol having a molecular structure including from one to six carbon atoms.

In some examples, the term “releasable contact” refers to a temporary contact between surfaces that may be separated from each other, for example, in response to a pulling force.

In some examples, the term “release liner” refers to a sheet temporarily adhered to or in releasable contact with a contact surface to prevent the contact surface from prematurely contacting or adhering to other surfaces. Release liners can be removed from the contact surface without substantially affecting adherence of the contact surface.

In some examples, the term “release profile” refers to the rate of release of an agent from a composition or film over time. The release profile may be described in terms of concentration of the agent in an environment around a source of the agent released over a predetermined period of time.

In some examples, the term “roll” refers to a cylindrical object formed by winding a sheet or film of flexible material about a predetermined axis to curve the sheet or film of flexible material on itself about the axis without creasing or folding.

In some examples, the term “self-supporting” refers to an ability of an article to retain a predefined shape (e.g., surface contour) without being supported by something else.

In some examples, the term “sheet” refers to a rectangular material having a breadth and length that are substantially, for example, orders of magnitudes, greater than a thickness of the material.

In some examples, the term “silver-based antimicrobial agent” refers to an antimicrobial agent having a chemical structure that includes at least one silver atom.

In some examples, the term “suture” or “suture thread” may refer to an absorbable or non-absorbable material configured to suture body tissue together, and may have any suitable size.

In some examples, the term “strip” refers to a sheet having a length that is substantially larger, for example, more than twice, than the breadth of the sheet.

In some examples, the term “surgical tray” refers to a tray capable of holding at least one object used in surgery, for example, a surgical tool or accessory.

In some examples, the term “tacky surface” refers to a surface that is sticky.

In some examples, the term “target surface” refers to a surface to which an antimicrobial effect is to be imparted.

In some examples, the term “thickness” refers to a shortest average distance between opposing major surfaces of a film or a sheet.

In some examples, the term “uniformly dispersed particles” refers to particles having a substantially spatially invariant population concentration within a matrix, for example, within a formulation or a film.

In some examples, the term “water permeable polymer” refers to a polymer that may be at least partially susceptible to hydration or wetting by water.

In some examples, the term “weight average molecular weight” refers to the statistical average molecular weight of all polymer chains in a polymeric sample, given by

$$\frac{\sum {M}_{i}^{2} {N}_{i}}{\sum {M}_{i} {N}_{i}} ,$$

where Mᵢ is the molar mass of the ith polymeric chain, and Nᵢ is the number of molecules having molecular mass Mᵢ.

The disclosure describes, in some examples, antimicrobial films that can be contact with, for example, temporarily, or substantially permanently, a target surface of a separate article to provide an antimicrobial effect to the target surface, for example, by eluting antimicrobial agents from the antimicrobial films. Compared to coating a target surface with an antimicrobial coating, for example, by dipping or immersion the target surface in a liquid formulation, applying antimicrobial films may be one or more of relatively convenient, faster, reversible, repositionable, selective, flexible, or inexpensive. For example, any surface to which the antimicrobial film is capable of adhering to can be relatively rapidly provided an antimicrobial effect by aligning the film with the surface and coupling (e.g., adhering) the film to the surface. Antimicrobial films according to the disclosure may include a water permeable polymer and uniformly dispersed particles therein of at least one antimicrobial agent. The present disclosure describes antimicrobial formulations with little to no agglomerated particles, which can be used to form antimicrobial films. Antimicrobial films may also provide a consistent elution of antimicrobial agents over a longer period of time from the target surface compared to some antimicrobial coatings.

The disclosure describes antimicrobial films that can be applied to target surfaces of separate articles to provide an antimicrobial effect to the target surfaces of the article, and techniques for forming and applying antimicrobial films. The disclosure also describes antimicrobial fibers that can be used to create an antimicrobial article, such as, but not limited, to, a suture thread, a wound dressing (e.g., a gauze pad, bandage, or butterfly dressing), an article of clothing (e.g., surgical scrubs, gloves, socks, or the like), a blanket, a sterile field drape, a shoe cover, a hairnet/hat, beard guard, or other article for covering the head/hair of a person, and the like. The antimicrobial article can be a woven or a nonwoven article. The antimicrobial article formed using the antimicrobial fibers described herein may themselves exhibit antimicrobial properties due to the presence of the antimicrobial fibers. In some examples, the antimicrobial articles described herein consistent essentially of antimicrobial fibers, e.g., may be formed primarily from the antimicrobial fibers, but for the addition of component used to connect or otherwise hold the antimicrobial fibers.

Antimicrobial formulations according to the disclosure can be prepared by milling the various ingredients, thereby minimizing the size of the insoluble particles and their tendency to agglomerate. Surprisingly, it has been found that by milling the various components as set forth below, not only are films prepared from the formulation smoother on being applied to a target surface, but also the elution rate of the antimicrobial agents from the film becomes more consistent over time, and the release rate appears to be better controlled over a longer period of time. Further, re-agglomeration of the insoluble antimicrobial components is eliminated, or nearly eliminated.

Further, instead of coating, washing, or cleaning target surfaces to remove or reduce microbial populations, applying antimicrobial films according to the disclosure to target surfaces may provide antimicrobial effects to the target surfaces, while being more convenient and leading to fewer processing steps and equipment downtime, by allowing “onthe-fly” and in-place application of antimicrobial films to provide antimicrobial effects to target surfaces. For example, a free-standing antimicrobial film according to the disclosure may be applied to a target surface by adhering a contact surface of the antimicrobial film to the target surface.

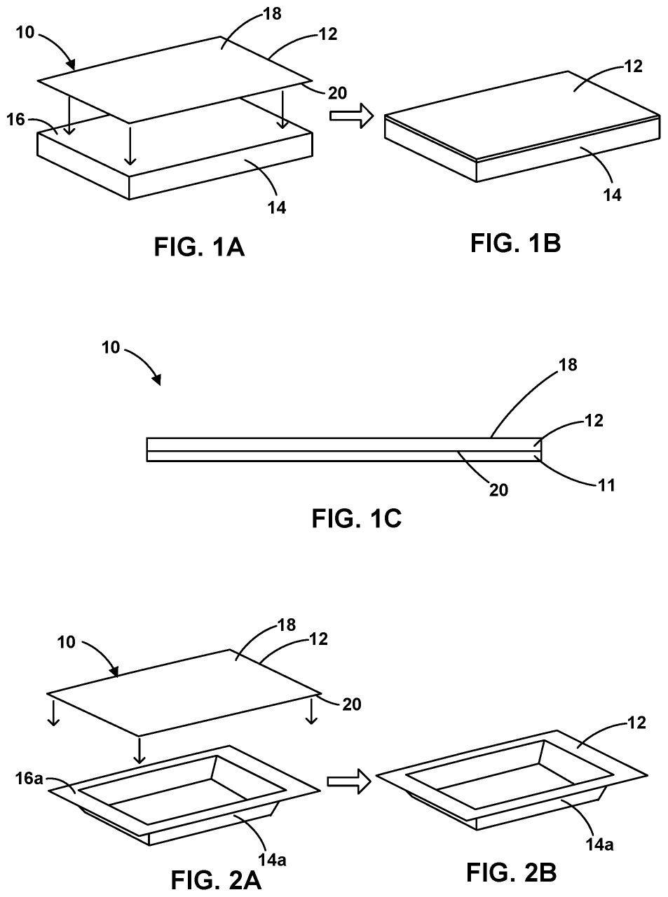

FIG. 1A is a schematic and conceptual illustration of an assembly including article 10 including an antimicrobial film 12 and a substrate 14 separate from antimicrobial film 12 and defining a target surface 16. Target surface 16 thus is a surface defined by a separate or second article including substrate 14 that is separate from antimicrobial film 12. Target surface 16 may be considered a surface of substrate 14 (e.g., target surface 16 may be defined by substrate 14), and antimicrobial film 12 may be applied to target surface 16, e.g., by covering all or a portion of target surface 16 with antimicrobial film 12. Antimicrobial film 12 defines a first major surface 18 and a second major surface 20 opposing first major surface 18. One or both of first major surface 18 or second major surface 20 define a contact surface configured to contact target surface 16. In the example shown in FIG. 1A, second major surface 20 defines the contact surface.

Antimicrobial film 12 may be aligned with substrate 14 to cover target surface 16 such that the contact surface faces target surface 16, and then antimicrobial film 12 may be applied to target surface 16 by bringing the contact surface into contact with target surface 16, as shown in FIG. 1B. In some examples, on applying antimicrobial film 12 to target surface 16, antimicrobial film 12 may get fixed, attached, secured, or adhered to target surface 16. In some examples, antimicrobial film 12 is in removable contact with or removably adhered to target surface 16 such that it is retained on target surface 16 during a predetermined period of use and then can be removed from target surface 16 after the period of use. Antimicrobial film 12 may adhere to target surface 16 by one or more of chemical, physical, or mechanical interaction, for example, hydrogen bonds, covalent bonds, ionic bonds, chemical adhesion, electrostatic interaction, capillary action, surface tension, or suction. For example, an intermediate fluid film, for example, a thin layer of water, may hold antimicrobial film 12 on target surface 16, for example, similar to a decal. In some such examples, the fluid may persist as long as antimicrobial film 12 is placed on target surface 16. In other such examples, the fluid may evaporate or otherwise dry after antimicrobial film 12 is placed on target surface 16.

Target surface 16 may be any surface to which it may be advantageous to provide an antimicrobial effect. For example, target surface 16 may include one or more of metal, alloy, polymer, glass, ceramic, wood, or composite. In some example, target surface 16 may be defined by substrate 14 of a component of a medical, food service, industrial, commercial, or residential component or object. For example, target surface 16 may be defined by a medical device or component, for example, a surgical tray, an operating table, an operating console, an implantable device, an external device, a medical tool or instrument, catheters, a luer of a medical device such as a catheter, a medical device package (e.g., a pouch for a catheter) or bandages (or other wound dressings). Medical devices include, for example, any medical device intended to be implanted in a patient such as dialysis catheters, urological catheters, enteral feeding tubes, staples, trocars, implants, titanium implants, respiratory tubes, surgical plates, surgical screws, wires, hernia mesh, and sutures. In some examples, antimicrobial films described herein may be used as antimicrobial wraps, e.g., to wrap or otherwise cover the surface of another article to provide antimicrobial properties to the article.

In some examples, target surface 16 may be defined by a food preparation table, or a food serving table, for example, a table in the kitchen or the serving area of a restaurant, café, cafeteria, or a food preparation or serving facility. In some examples, target surface 16 may be defined by an industrial component or surface, for example, in a food, chemical, pharmaceutical, or biotechnology manufacturing or compounding facility. In some examples, target surface 16 may be defined by office supplies or office furniture. In some examples, target surface 16 may be defined by residential or household supplies or furniture, for example, kitchen countertops, sinks, dining tables, plumbing, toilets, or bathroom surfaces. In some examples, target surface 16 may include a wound dressing, a Tegaderm-type fixative, or an antimicrobial surface in a clinical or hospital setting (TEGADERM™ is a wound dressing made available by 3M Company of St. Paul, Minn.). Additionally, target surface 16 may include coverings for floors and/or floor mats, or films for keypads/controls for equipment, for example, medical, industrial, commercial, or residential equipment.

In some examples, target surface 16 may be defined by handle, handle guard or cover, or other surface of a lighting device (e.g., a light used for illumination of a room such as an operating room). FIG. 13 is a diagram illustrating an example handle guard 60 for an operating room lighting device, wherein the handle guard defines target surface 16. Handle guard 60 is configured to fit over a light handle of the operating room lighting device and may be, for example, relatively flexible or rigid. In other examples, target surface 16 may be any other surface in an operating room or other room, including a surface that a person may touch in an operating room or other room setting, such as a door (e.g., door handle), faucet, switch to turn a light on/off, and the like. In some examples, a door may include a rectangular or other shaped plate affixed to the door, e.g., to define a surface for a user to push open the door. For example, the plate may come into contact with a user's hand or arm to open the door. In such cases, the plate on the door may define target surface 16. Antimicrobial film 12 may include an adhesive to affix film 12 to the plate on the door.

In some examples, target surface 16 may be defined by the floor or floor mat, e.g., of an entry way into a room such as an operating room or clean room facility, and antimicrobial film 12 may be applied to target surface 16 such that a subject's shoes or a device's wheels or legs contact antimicrobial film 12 as the subject or device moves over the floor or floor mat. In some such examples, film 12 may have a thickness of about 50 microns to about 80 microns (e.g., for desired durability while also conforming to the surface of the underlying floor or floor mat. Adhesive may be applied to one surface of film 12 to help keep film 12 affixed to the floor or floor mat. In some examples, film 12 may include a tab one or more corners that allows for film 12 to be removed from the floor or floor mat as desired.

In some examples, target surface 16 may be defined by sterile field drapes. In some examples, examples of the antimicrobial film itself may be used as a sterile field drape. In some examples, target surface 16 may be defined by shoes or shoe covers, hairnet/hat or other article for covering the head/hair of a person, gloves, socks, scrubs or other clothing (e.g., to be worn by medical personal in an operating room setting such as pants, shirts, surgical masks, and the like).

In some examples, substrate 14 defining target surface 16 may be a nonwoven material such as a SMS (spunbond+meltblown+spunbond) nonwoven material or a central supply room (CSR) wrap material. Antimicrobial film 12 may be applied to target surface 16 of such a nonwoven material, and the nonwoven material may act as a based material onto which film 12 may be applied. In some such applications, antimicrobial film 12 may be about 20 microns to about 50 microns thick, may conform to the underlying surface of the nonwoven base material, and may be applied to one or both sides of such a base material depending on the application. The assembly including film 12 and the nonwoven base material may be used to form any desired article, such a surgical scrubs, gowns, surgical drapes, shoe covers or booties, hair guards, beard guards, hats, or the like. A CSR wrap material may act as a barrier against both air and waterborne bacteria.

In some examples, target surface 16 may be defined by a phone, computer keyboard, laptop, security panel/keypad, mobile computing device such as a smart phone, or other device having a keypad or other user input surface used for user input, such as a touchpad, or other user interaction with the device through the user touching the surface of the device. In some examples, an antimicrobial film 12 applied to a keyboard, other user input surface, or other target surface such as those described herein may be translucent so as to enable to a user to view the underlying target surface 16, may be from 50 microns to 60 microns thick, or 20 microns to 40 microns thick, or 20 microns to 30 microns thick (e.g., a reduced thickness may improve visibility of key characters or other graphics on the surface through film 12). Antimicrobial film 12 may be configured to conform to the contours of the geometry of a keyboard, e.g., the individual keys, or other nonplanar portions of target surface 16. For example, antimicrobial film 12 may be flexible and conformable to the keyboard surface or other target surface 16 or may be more rigid (e.g., self-supporting) and be preformed to overlay and mate with the keyboard surface or other target surface 16. Antimicrobial film 12 may be configured to cover substantially all of a input surface of a keyboard or only portions of the keyboard, such as individual keys. Antimicrobial film 12 may cover target surface 16, e.g., in the form of a keyboard, as a single film or a plurality of individual films applied to portions of target surface 16, e.g., individual keys of a keyboard.

In some examples, antimicrobial films described herein may be used as a medical wrap or dressing (such as butterfly dressings or other wound dressing). In some examples, a wrap or dressing may include an adhesive backing. In some examples, antimicrobial films described herein may be applied directly onto a patient, e.g., a human patient. For example, an example antimicrobial film may be applied directly to the skin of a human patient. In such a manner, the antimicrobial film may be in direct contact with the skin on the human patient. The antimicrobial film may be secured to the skin of a human patient, e.g., by an adhesive layer on the film, by friction, or other manners or combinations thereof. In examples in which an adhesive is used to help secure the antimicrobial film in place relative to the patient, the antimicrobial film may be separated from the skin of the patient by an adhesive layer or may still be in directly contact with the skin, e.g., by wrapping the antimicrobial film around a limb, torso, or other portion of the patient and using the adhesive to adhere the film directly to itself to help secure it in place.

In some examples, the antimicrobial film itself may be a securement dressing configured to secure a catheter or another medical device to an external surface of a patient. An example of a securement dressing is the TEGADERM™ securement dressing (made available by 3M Company of St. Paul, Minn.), which may be used in a clinical setting, e.g., to secure dialysis catheter at the exit site, where the dressing is in direct contact with the patient's skin.

In some examples, target surface 16 may host or receive microbial populations, for example, originating from ambient environment, or from contaminated sources. While antimicrobial coatings may be used to reduce microbial populations, applying a coating may entail removing substrate 14 from its surroundings or processing substrate 14 in a coating facility, which may be cumbersome, and lead to non-operational periods of substrate 14. Applying coatings may also be relatively expensive, or require one or more stages of industrial processing. While microbial populations may be reduced by cleaning and washing, for example, using detergents and antimicrobial liquids or sprays, it may be advantageous to avoid recurring washing or cleaning. Further, cleaning agents may leave undesirable residues.

Instead of, or in addition to, coating or cleaning target surface 16, target surface 16 may be provided with an antimicrobial effect by applying antimicrobial film 12 to target surface 16. Further, during the fabrication or manufacture of substrate 14 or an article including substrate 14, substrate 14 may not have been provided with an antimicrobial surface. Antimicrobial film 12 may be used to provide an antimicrobial surface to substrate 14 while keeping substrate 14 within or near an operating environment of substrate 14. Thus, any article including substrate 14 may be provided with an antimicrobial surface even after fabrication of manufacture of substrate 14. Applying antimicrobial film 12 may avoid or reduce the need for removing substrate 14 from its operating or usage environment, or may avoid or reduce the need for cleaning, processing, or treating substrate 14 or target surface 16 to reduce or remove microbial populations or to maintain populations under predetermined thresholds.

In the example applications described herein and other applications, antimicrobial film 12 may be configured to conform to target surface 16 onto which film 12 is applied, e.g., via bonding of film 12 to target surface 16.

FIG. 1B is a schematic and conceptual illustration of the assembly of FIG. 1A in which antimicrobial film 12 is applied to target surface 16 of substrate 14. In some examples, antimicrobial film 12 applied to target surface 16 of substrate 14 provides an antimicrobial effect to target surface 16.

In some examples, antimicrobial film 12 may be activated to provide the antimicrobial effect. The activation may include hydration or wetting of antimicrobial film 12, to allow elution or diffusion of antimicrobial compounds or species from antimicrobial film 12. For example, antimicrobial film 12 may be wetted or hydrated with water, atmospheric moisture, an aqueous solution, a buffer, or any suitable fluid or gel. In some examples, antimicrobial film 12 may be activated prior to being applied to target surface 16, for example, in a container, or in a package containing antimicrobial film 12. In other examples, antimicrobial film 12 may be activated on or after being applied to target surface 16, for example, by water, atmospheric moisture, aqueous solutions, buffers, sweat, exudates, or bodily fluids.

In some examples, antimicrobial film 12 may form a barrier to transport of microbial organisms across antimicrobial film 12. In some examples, at least one antimicrobial agent elutes or leaches from antimicrobial film 12 to provide the antimicrobial effect. In some examples, the antimicrobial effect includes at least one of a bacteriostatic effect, a bactericidal effect, or an antifungal effect. For example, the presence of antimicrobial film 12 may reduce microbial populations, or prevent the growth of microbial populations, on or adjacent target surface 16. In this way, antimicrobial film 12 may be used to provide an antimicrobial effect to any target surface 16 in one or more of medical, industrial, residential, or commercial environments.

Antimicrobial film 12 may have any suitable thickness that promotes usability and functionality. For example, the thickness of antimicrobial film 12 may be selected to enable antimicrobial film 12 to be applied to target surface 16 without unintentional tearing, perforation, stretching, or breakage. As examples, antimicrobial film 12 may have a thickness in a range from about 5 microns to about 1000 microns, or from about 10 microns to about 100 microns, or from about 100 microns to about 1000 microns, or from about 20 microns to about 80 microns, or from about 45 to about 65 microns, or about 50 microns, or about 55 microns, or from about 50 to 60 microns. In some examples, different regions of antimicrobial film 12 may be provided with different thicknesses, for example, depending on the geometry or conformation of different regions of target surface 16. For example, the thickness may be selected to reduce interference with the function of the underlying article. As an example, if antimicrobial film 12 is applied to a threaded fitting (e.g., a luer fitting of a catheter), then the thickness of antimicrobial film 12 may be selected to reduce the interference of the threaded fitting interacting with the threads of a cap or other device to which the threaded fitting is intended to mate.

In some examples, a relatively greater thickness of antimicrobial film 12 may result in a relatively slower release rate. Thus, in some examples, the thickness of antimicrobial film may be determined based on predetermined target release rates of the antimicrobial agents for particular applications of antimicrobial film 12. In some examples, the relative amount of water-absorbing groups present in the polyurethane resin may also influence the rate of release of the antimicrobial agents. For example, less water-absorbing groups may slow the rate of release of the active ingredients.

In some examples, antimicrobial film 12 may be substantially clear or transparent, so that the presence of antimicrobial film 12 may not be visibly perceptible or otherwise affect the visual appearance of target surface 16. In other examples, antimicrobial film 12 may be translucent, opaque, or have a tint, such as a brownish tint or another colored tint. In some examples, antimicrobial film 12 may include a contrast agent, for example, a tint, a dye, or a pigment, so that the presence of antimicrobial film 12 can be visually verified. In some examples, the contrast agent may be perceptible in a predetermined light spectrum, for example, only under ultraviolet (UV) exposure. In some examples, antimicrobial film 12 may include or define symbols, logos, words, or other indicia indicating that target surface 16 is provided with an antimicrobial effect by antimicrobial film 12. In some examples, antimicrobial film 12 may include a moisture indicator, for example, a species that exhibits a visible change, for example, a change in color, in response to hydration or moisture. For example, the moisture indicator may exhibit a first color when moisture or water in antimicrobial film 12 is below a predetermined threshold and exhibit a second color when moisture or water in antimicrobial film 12 exceeds the predetermined threshold.

One or both of first or second major surfaces 18 and 20 of antimicrobial film 12 may define a contact surface that can be adherable to target surface 16. For example, the contact surface may include one or more of a tacky surface, an adhesive surface, or an electrostatic surface compatible with target surface 16.

For example, FIG. 1C is a schematic and conceptual side view of antimicrobial film 12 of FIG. 1A including an adhesive layer 11. Adhesive layer 11 includes the adhesive agent. In some examples, adhesive layer 11 may define the adhesive surface. In the example shown in FIG. 1C, single adhesive layer 11 is formed adjacent second major surface 20 of antimicrobial film 12. However, the adhesive agent may be applied to one or both of first or second major surfaces 18 or 20 to form one or two adhesive layers. In some examples, adhesive layer 11 may include, instead of, or addition to, the adhesive agent, a tackifier. In some such examples, adhesive layer 11 may define the tacky surface. The adhesive agent may include any suitable adhesive formulation, for example, a pressure-sensitive adhesive, a silicone-based adhesive, or a biocompatible adhesive. The tackifier may include any suitable tacky formulation, for example, including natural or synthetic resins.

In some examples, the contact surface may remain in contact with target surface 16 without an adhesive agent, for example, by clinging to target surface by electrostatic or other surface interactions. In some examples, antimicrobial film 12 may be wetted with a wetting agent, for example, water or another compatible wetting agent, to promote the adhering of antimicrobial film 12 to target surface 16 (for example, like a decal).

In some examples, antimicrobial film 12 may be removable from target surface 16. For example, antimicrobial film 12 may be removed from target surface 16 in response to a determination of reduced antimicrobial effect, and replaced with fresh antimicrobial film. In some examples, antimicrobial film 12 may be formulated to be removed from target surface 16 by one or more of mechanical, physical, or chemical action, for example, scraping, abrasion, cutting, pulling, exposure to heat, or washing with water or a suitable solvent compatible with the formulation of antimicrobial film 12.

Antimicrobial film 12 includes at least one water permeable polymer including uniformly dispersed particles of at least one antimicrobial agent. In some examples, polymers and/or antimicrobial agents that may be useful for forming antimicrobial film 12 may be not readily soluble. In some such examples, such ingredients may tend to form agglomerated particles in formulations used to form antimicrobial film 12, ultimately leading to the presence of agglomerated particles in antimicrobial film 12, or on or adjacent target surface 16. Even when the initial size of the particles used in preparing antimicrobial film 12 is as small as several microns, the particles can agglomerate resulting in agglomerated particle sizes as large as several hundred microns. Such agglomerated particles may result from the agglomeration of many smaller sized particles that agglomerate during formation of antimicrobial film 12 from an antimicrobial formulation.

Such agglomerated particles may adversely increase the surface roughness of antimicrobial film 12 and ultimately that of target surface 16 of substrate 14. In addition, the size and shape of the agglomerated particles can adversely affect the dissolution or release of the antimicrobial agent from antimicrobial film 12. To avoid adverse effects, the average size of particles and agglomerates may be maintained lower than a predetermined threshold. In some examples, the particles and any agglomerations of the antimicrobial agent have an average size of no greater than 50 microns. For example, antimicrobial film 12 may include particles having a mean particle size and mean agglomeration size of no greater than about 50 microns, no greater than about 40 microns, no greater than about 30 microns, no greater than about 20 microns, no greater than about 10 microns, no greater than about 5 microns, in a range from about 0.5 to about 5 microns, from about 0.5 to about 20 microns, from about 0.5 to about 50 microns, from about 1 to about 10 microns, from about 1 to about 20 microns, from about 1 to about 30 microns, from about 1 to about 40 microns, from about 1 to about 50 microns, and numbers therebetween.

In some examples, the water-soluble polymer in antimicrobial film 12 defines a bulk or a matrix of antimicrobial film 12 in which particles of antimicrobial agents are uniformly dispersed. Polymers useful for forming antimicrobial film 12 include polymers that are water-permeable and are formable into a film compatible with target surface 16 such as, for example, a polyurethane, such as a thermoplastic polyurethane elastomer, a polyester, polylactic acid, polyglycolic acid, polytetramethylene glycol, polyacrylamide, polyacrylic acid, polyacrylate, poly(2-hydroxyethyl methacrylate), polyethylene-imine, poly-sulfonate and copolymers thereof such as poly(lactic acid-co-glycolic acid) (PLA/PGA), polyacrylic-co-hydroxylated-acrylate, poly(acrylic acid-co-2-hydroxy ethyl methacrylate). In one aspect of the present disclosure, the polymer is a thermoplastic polyurethane elastomer, such as Pellethane (Lubrizol Advanced Materials, Wickliffe, Ohio, USA).

In some examples, the molecular weight of the polymer is sufficiently high enough to form a free-standing film but not so high as to prevent a formulation of the polymer from being cast into antimicrobial film 12. Such polymers may have a weight average molecular weight (Mw), for example, of from about 20,000 to about 500,000 Daltons, e.g. in a range from about 50,000 to about 200,000, or from about 70,000 to about 120,000 Daltons. The weight average molecular weights can be determined by using GPC analysis having a refractive index detector coupled with a light scattering detector for absolute molecular weight measurement of weight average molecular weight (Mw).

In some examples, one or more polymers in antimicrobial film 12 may provide antimicrobial film 12 with one or more of a predetermined flexibility, conformability, or elasticity to allow antimicrobial film 12 conform and contact uniformly along target surface 16. For example, while target surface 16 is substantially flat or planar in the example shown in FIG. 1A, in other examples, target surface 16 may define a curved surface, a polygonal surface, or a compound surface including one or more curved, flat, or angled surfaces. Further, while target surface 16 is substantially smooth in the example shown in FIG. 1A, in other examples, target surface 16 may define a rough, uneven, or irregular surface. In some such examples, flexibility, conformability, or elasticity of antimicrobial film 12 may allow a substantially uniform application of antimicrobial film 12 to target surface 16, without the formation of creases and air gaps or bubbles, or the trapping of dust or debris, between antimicrobial film 12 and target surface 16.

In other examples, antimicrobial film 12 is configured to be relatively rigid, e.g., self-supporting. For example, the antimicrobial film 12 may be rigid enough to retain a predefined shape without being supported by something else. In these examples, the antimicrobial agent 12 may form a self-standing article, such as a relatively rigid keyboard or keypad cover that defines a surface profile that is configured to engage with a keyboard or keypad or another article that defines a predefined surface profile.

Molecules of the antimicrobial agents may be released from the particles, and may diffuse or otherwise migrate from an interior of antimicrobial film 12 to one or both of major surfaces 18 or 20 of antimicrobial film 12. Ultimately, molecules of the antimicrobial agents may leach from antimicrobial film 12, for example, from first or second major surfaces 18 or 20, into an adjacent or surrounding environment, providing the antimicrobial effect at or adjacent antimicrobial film 12.

Antimicrobial agents that are useful for the present disclosure include, for example, silver-based antimicrobial agents; polybiguanides and salts thereof; chlorhexidine and salts thereof such as the dihydrochloride, diacetate and digluconate salt of chlorhexidine; hexachlorophene; cyclohexidine; chloroaromatic compounds such as triclosan; para-chloro-meta-xylenol.

Silver-based antimicrobial agents include, for example, silver particles; a silver nitrate; silver halides, e.g., silver fluoride, chloride, bromate, iodate; silver acid salts, e.g., silver acetate, silver salicylate, silver citrate, silver stearate, silver benzoate, silver oxalate; silver permanganate; silver sulfate; a silver nitrite; silver dichromate; silver chromate; silver carbonate; silver phosphate; silver (I) oxide; silver sulfide; silver azide; silver sulfite; silver thiocyanate; and silver sulfonamide, such as a silver sulfadiazine. Antimicrobial agents that are not readily soluble in a formulation are particularly advantageous in the present disclosure.

In some examples, the antimicrobial agents include a combination of a silver-based salt and a polybiguanide salt, i.e., a combination of silver sulfadiazine and chlorhexidine diacetate. For example, the antimicrobial agent in antimicrobial film 12 may include a silver-based salt and a polybiguanide salt. In some examples, the silver-based salt is silver sulfadiazine, and the polybiguanide salt is chlorhexidine diacetate. In some examples, antimicrobial film 12 includes silver sulfadiazine in a range from about 2 weight percent (wt. %) to about 10 wt. %, at least 9 wt. % of chlorhexidine diacetate, and the water permeable polymer in a range from about 70 wt. % to about 90 wt. %. In some such examples, antimicrobial film 12 has a release profile such that at least 0.50 μg/cm of silver is continuously released after 150 hours. In some such examples, antimicrobial film 12 has a release profile such that at least 10 μg/cm of chlorhexidine diacetate is continuously released after about 150 hours.

The average particle size (surface area) and solubility of the antimicrobial agents and the water permeability of the polymer may affect the release rate of the antimicrobial agent from antimicrobial film 12. In some examples, the antimicrobial agent in antimicrobial film 12 includes silver sulfadiazine, and antimicrobial film 12 has a release profile wherein at least 0.50 micrograms per centimeter (μg/cm) of silver is continuously released after 72 hours. In some examples, antimicrobial film includes chlorhexidine diacetate, and at least 10 μg/cm of chlorhexidine diacetate is continuously released after 72 hours.

For example, relatively more water-soluble antimicrobial agents such as chlorhexidine gluconate will have a higher release rate whereas the relatively water insoluble hydrochloride salt releases slowly. In some examples, antimicrobial film 12 includes from about 70% by weight (wt %) to 90 wt % of a polyurethane polymer, from 2 wt % to about 10 wt % silver sulfadiazine, e.g. from about 3.5 wt % to about 7 wt % and a minimum amount of chlorhexidine diacetate of about 9 wt %, 10 wt %, or about 11 wt %. Such an antimicrobial film 12 can be formed to have a release profile wherein at least 0.50 μg/cm of silver is continuously released after 75 hours, e.g., after about 100 hours, 150 hours and higher, and wherein at least 10 μg/cm of chlorhexidine diacetate is continuously released after 75 hours e.g., after about 100 hours, 150 hours and higher.

Thus, antimicrobial film 12 may be applied to any suitable target surface, such as target surface 16, to provide an antimicrobial effect, for example, by elution or leaching or antimicrobial agents. While a substantially target surface 16 may be substantially planar, as shown in FIGS. 1A and 1B, in other examples, substrate 14 may define complex or compound target surface 16 including multiple planar or curved regions.

For example, FIG. 2A is a schematic and conceptual illustration of an assembly including an example article 10 including antimicrobial film 12 and a tray 14a separate from antimicrobial film 12, tray 14a defining target surface 16a. As seen in FIG. 2A, target surface 16a defined by tray 14a is a compound surface including different angled panels. Tray 14a may be a tray configured to hold one or more objects. For example, target surface 16a may define a holding surface on which one or more objects may be placed. In some examples, tray 14a may be a food service tray, a cafeteria tray, a medical tray, a surgical tray, or a dental tray. FIG. 2B is a schematic and conceptual illustration of the assembly of FIG. 2A in which antimicrobial film 12 is applied to target surface 16a of tray 14a. As seen in FIGS. 2A and 2B, while antimicrobial film 12 may initially be flat, it may yet be sufficiently flexible, conformable, or elastic to deform without breaking and to substantially uniformly cover target surface 16a. In some examples, a single sheet, strip, or portion of antimicrobial film 12 may be applied to compound surfaces, for example, target surface 16a. In other examples, a plurality of antimicrobial films may be applied to different panels or surfaces of target surface 16a.

In some examples, target surface 16 or 16a may define one or more holes, openings, perforations, or discontinuities. In some such examples, antimicrobial film 12 may define one or more holes, openings, perforations, or discontinuities confirming to target surface 16 or 16a. Even if antimicrobial film 12 is perforated at some location(s), film 12 may still function with the desired antimicrobial properties due to the active ingredients of film 12 discussed above.

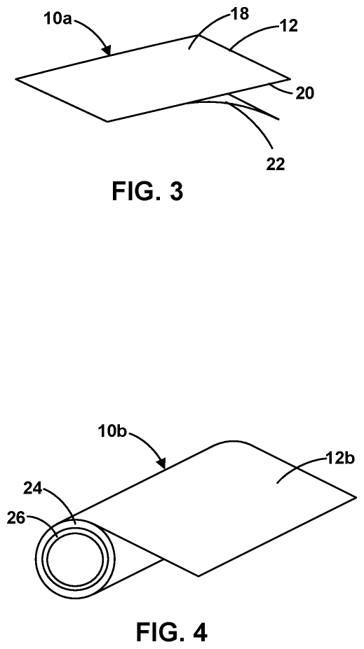

FIG. 3 is a schematic and conceptual illustration of an article 10a including antimicrobial film 12 and a release liner 22 applied to a contact surface defined by antimicrobial film 12. In examples in which second major surface 20 defines the contact surface, release liner 22 may be applied opposing first major surface 18. While a single release liner 22 is shown in the example illustrated in FIG. 3, in other examples, article 10a may include more than one release liner. For example, release liner 22 may be a first release liner in contact with second major surface 20, and article 10a may include a second release liner in contact with first major surface 18. Thus, the contact surface may be in releasable contact with release liner 22. Release liner 22 may include one or more of a woven fabric, a nonwoven fabric, a film, wax, silicone, paper, or plastic that is releasable from the contact surface of antimicrobial film 12. In some examples, release liner 22 includes a laminate. Release liner 22 may protect the contact surface from premature or unintentional adhesion to target surface 16 or another surface. Further, while release liner 22 has a substantially continuous surface and a periphery that conforms to a periphery defined by antimicrobial film 12, in other examples, release liner 22 may define one or more discontinuities, perforations, or segments, such that portions of release liner 22 may be separately be released from antimicrobial film 12. In some examples, a plurality of release liners 22 may be applied to antimicrobial film 12.

In some examples, one or both of antimicrobial film 12 or release liner 22 may be cut or otherwise fabricated to fit a geometry of target surface 16, such that substantially all of an intended antimicrobial surface of target surface 16 is covered with antimicrobial film 12 after it is applied to target surface 16. For example, one or both of antimicrobial film 12 or release liner 22 may define any closed complex or compound shape including one or more linear or curved segments, including polygons, ellipsoids, or any predetermined closed shape, or any shape conforming to target surface 16. Further, while antimicrobial film 12 and release liner 22 may be substantially flat or planar as shown in FIG. 3, in other examples, antimicrobial film 12 and release liner 22 may define any suitable three-dimensional complex or compound shape including curved or planar sections, or any three-dimensional shape conforming to target surface 16.

FIG. 4 is a schematic and conceptual illustration of an article 10b including an antimicrobial film 12b defining a roll 24 wound about a core 26. The formulation of antimicrobial film 12b may be substantially similar to that of antimicrobial film 12 described with reference to antimicrobial film 12 of FIGS. 1A, 1B, 2A, 2B, and 3. Roll 24 includes a plurality of windings of antimicrobial film 12b. Core 26 may include paper, plastic, metal, or any suitable material. Core 26 may be hollow, as shown in the example illustrated in FIG. 4, or may be substantially solid. Core 26 may be provided with retainers, for example, at the ends of core 26, to hold core 26 within a dispensing container, to allow core 26 to rotate or spin while a predetermined portion of antimicrobial film 12b is removed from roll 24. Antimicrobial film 12b may be provided with perforations or partial cuts to facilitate separation and removal of predetermined portions of antimicrobial film 12b from roll 24. The spacing between and the length of the perforations may be selected based on the application for film 12b. In some examples, article 10b may not include core 26, and may only include roll 24 of antimicrobial film 12b. In some examples, roll 24 may include release liner (not shown) rolled with antimicrobial film 12b. The release liner may be similar to release liner 22 described with reference to FIG. 3.

Thus, antimicrobial films according to the disclosure may optionally be formed in different shapes and optionally provided with release liners, facilitating the protection, holding, and manipulation of antimicrobial films before or during application to target surfaces.

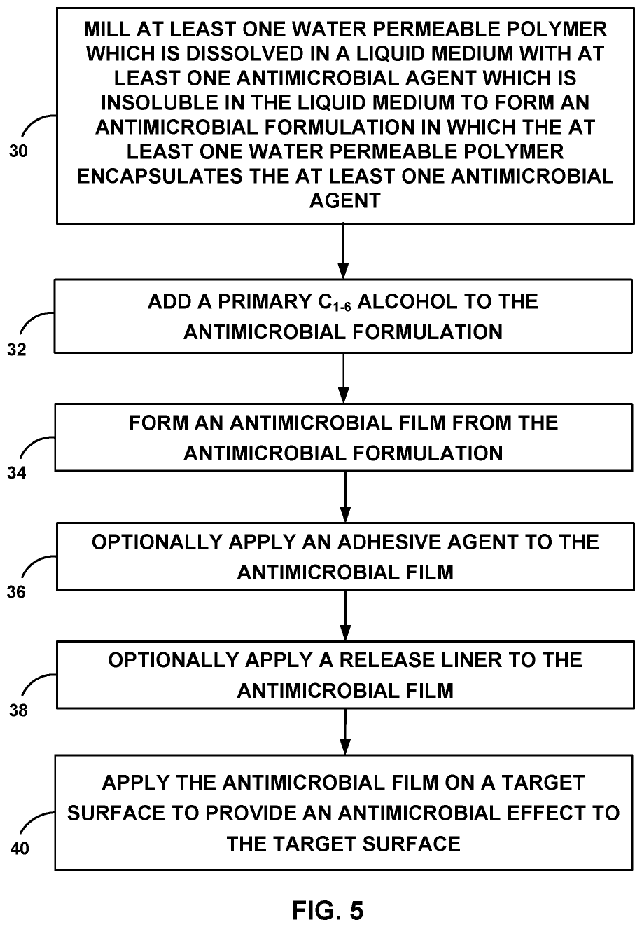

FIG. 5 is a flowchart illustrating an example technique for forming antimicrobial film 12. While the example technique of FIG. 5 is described with reference to article 10 and antimicrobial film 12 described with reference to FIGS. 1A and 1B, example techniques according to the disclosure may be used to form any antimicrobial film according to the disclosure.

In some examples, the example technique includes milling at least one water permeable polymer which is dissolved in a liquid medium with at least one antimicrobial agent which is insoluble in the liquid medium to form an antimicrobial formulation (30). The at least one water permeable polymer encapsulates the at least one antimicrobial agent. The least one antimicrobial agent includes a silver-based antimicrobial agent, and wherein the at least one water permeable polymer includes at least one of a polyurethane or a thermoplastic polyurethane elastomer, as described with reference to antimicrobial film 12 of FIG. 1A.

In some examples, the antimicrobial formulation for forming antimicrobial film 12 is formed by milling at least one polymer with at least one antimicrobial agent in a liquid medium to form the antimicrobial formulation. As an example, the milling may be performed in a high-shear miller that reduces particle size and prevents agglomeration of particles in the formulation. Formulations containing one or more insoluble ingredients are particularly useful in practicing the present disclosure. Such formulations include a liquid medium, at least one polymer, and at least one antimicrobial agent that is not soluble in the formulation. The formulation can also include other ingredients that are useful in forming antimicrobial films. Example antimicrobial formulations that can be used to prepare antimicrobial film 12 are described in U.S. Pat. No. 9,789,228, the disclosure of which is herein incorporated by reference in its entirety.

The liquid medium may include one or more liquids that are useful for dissolving or suspending the polymer and/or antimicrobial agent and allowing the formulation to flow or be cast into antimicrobial film 12. Such liquids include, for example, one or more of the following: an alcohol and lower alcohol, e.g., a C₁₋₁₂ alcohol, such as methanol, ethanol, n-propanol, isopropanol, n-butanol, isobutanol, furfuryl alcohol; a polyhydridic alcohol, such as ethylene glycol, a butanediol, a propanediol; an ether, such as a linear, branched or cyclic lower ether, dimethyl ether, ethyl ether, methyl ethyl ether, tetrahydrofuran; a ketone such as a linear, branched or cyclic lower ketone, such as acetone, methyl ethyl ketone, cyclohexanone; an organic acid, such as formic acid, acetic acid, butyric acid, benzoic acid; an organic ester, such as a formate, ethyl or methyl acetate, propionate; an amide such as a linear, branched or cyclic lower amide, such as dimethylacetamide (DMAC), pyrrolidone, 1-Methyl-2-pyrrolidinone (NMP), a hydrocarbon, such as a linear, branched or cyclic alkane, such as a pentane, hexane, heptane, octane, cyclohexane, a linear, branched or cyclic alkene, an aromatic solvent or liquid; and a halogenated solvent or liquid such as a chlorinated solvent or liquid.

The example technique of FIG. 5 includes adding a primary C₁₋₆ alcohol to the antimicrobial formulation (32). For example, the liquid medium includes a primary alcohol, e.g., a primary C₁₋₆ alcohol such as methanol, ethanol, n-propanol, n-butanol, n-pentanol, n-hexanol in the formulation. In some examples, the use of a primary C₁₋₆ alcohol, such as n-propanol, facilitates forming antimicrobial film 12 from the formulation. For example, n-propanol has a beneficial balance between the length of the aliphatic chain and the hydroxyl group. Also, when used with tetrahydrofuran (THF), n-propanol has a desirable boiling point of 99 degrees Celsius (° C.), which allows it to stay at the forming surface longer than THF which in turn improves flow and leveling of the formulation while forming antimicrobial film 12.

Milling the one or more polymers and antimicrobial agents in liquid media offers an advantage of forming uniform antimicrobial formulations that can be used to form antimicrobial film 12. Without being bound by theory, milling, rather than mixing such as with a high shear mixer, a liquid medium including the at least one water permeable polymer with the at least one antimicrobial agent enables the antimicrobial agent to be uniformly dispersed in the liquid medium and/or to be encapsulated within the polymer such that the antimicrobial agent does not re-agglomerate prior to and during forming antimicrobial films from antimicrobial formulations. The encapsulated agent in the formulation is believed to provide a more consistent elution rate and prevent the re-agglomeration of particles over time.

The milling of the formulation (30) can be carried out using a high-shear miller such as a roll mill. Milling media useful for the present disclosure include Yttria stabilized zirconia grinding media, ⅜ inch (about 9.53 millimeters) cylinder shape (Inframat Advanced Materials, Manchester, Conn.).

In some examples, at least one antimicrobial agent is insoluble in the formulation and the formulation is milled (30) until the insoluble antimicrobial agent has a mean particle size of no greater than about 50 microns, such as no greater than 40 microns, 30 microns, 20 microns, 10 microns, 5 microns and numbers therebetween. In one embodiment, the mean particle size is approximately 5 microns. Mean particle size determinations can be made by a laser diffraction particle size analyzer, such as the Microtrac 53500 (Microtrac, Montgomeryville, Pa.) with a circulating loop to suspend the sample during analysis. Advantageously, the particles formed in the formulation after milling resist agglomeration both in the bulk formulation and in the antimicrobial film 12

In some examples, the milling (30) includes initially preparing a polymer solution. Such polymer solutions preferably have a viscosity and wetting properties that allows the formulation to smoothly flow over the forming surface of the device to facilitate forming a uniform antimicrobial film. The amount of the polymer in the formulation to provide an appropriate viscosity will depend on the polymer, liquid medium and molecular weight of the polymer.

In some examples, viscosities suitable for the formulation range from about 100 centipoise (cP) to about 10,000 cP, e.g. from about 100 cP to about 1,000 cP, preferably from about 500 cP to about 1000 cP. In some examples, from about 5 wt % to 30 wt % of the polymer can be combined with the liquid medium to form the solution with the appropriate viscosity. In some examples, preparing an antimicrobial formulation includes initially preparing a polymer solution having a viscosity of from about 100 centipoise (cP) to about 1,000 cP by dissolving the polymer in the liquid medium and then adding the antimicrobial agent to the solution followed by milling the formulation.

Additional antimicrobial agents can be added to formulations according to the disclosure. Such additional antimicrobial agents can be added neat or in a solution with a liquid medium such as in a primary C₁₋₆ alcohol. After adding additional antimicrobial agents, the formulation can be milled (30) to form a more or less homogeneous mixture with particles having a mean particle size of no greater than about 50 microns, such as no greater than 40 microns, 30 microns, 20 microns, 10 microns, 5 microns and numbers there between.

The example technique of FIG. 5 includes forming antimicrobial film 12 from the antimicrobial formulation (34). For example, antimicrobial film 12 can be formed prior to being applied to target surface 16. As described with reference to FIG. 1A, following the forming (34), antimicrobial film 12 defines a contact surface configured to contact target surface 16 to provide an antimicrobial effect to target surface 16. In some examples, the antimicrobial formulation comprises uniformly dispersed particles of the at least one antimicrobial agent, wherein the particles and any agglomerations of the antimicrobial agent have an average size of no greater than 50 microns.

Antimicrobial film 12 can be formed by applying or coating the antimicrobial formulation on a working substrate, curing or drying the antimicrobial film 12, and removing free-standing antimicrobial film 12 from the working substrate. The working substrate may include any suitable substrate on which the formulation may be applied and dried to form antimicrobial film 12, and from which antimicrobial film 12 can be released while maintaining the integrity of the formed antimicrobial film 12. For example, the working substrate can be formed from releasable thermoplastic olefin (TPO), glass, plastic, silicone, or a non-stick or low surface tension surface. The working substrate may be substantially flat or planar, or may be a rotating roll or moving belt on which a stream of the formulation may be continuously applied and from which formed antimicrobial film 12 may be continuously removed. The formulation can be applied to the working substrate in any way that allows the formulation to flow over and coat the working substrate. For example, the formulation may be applied by brushing, spraying, dripping, padding, squeezing, extruding, or drawing the formulation along the working substrate. The formulation may be dried, cured, or allowed to dry or cure, and the dried or cured formulation may be removed from the working surface to form antimicrobial film 12. For example, the formulation may be allowed to dry on the working substrate. Drying can include heating the formulation applied to the working substrate or allowing the formulation to dry on the working substrate to dry at room temperature. The optional curing may, depending on the composition of the formulation, include one or more of light, thermal, or chemical curing, for example, by exposure to predetermined wavelengths such as ultraviolet wavelengths, exposure to a predetermined curing temperature, or curing by chemical cross-linking between components of the formulation.

The thickness of antimicrobial film 12 may ultimately depend on the thickness of the formulation as applied to the working substrate. Thus, the formulation may be coated with a predetermined thickness to yield antimicrobial film 12 having a final predetermined thickness after curing and/or drying.

In some examples, a working substrate may not be used, and antimicrobial film 12 may be formed by extruding a sheet from the antimicrobial formulation. For example, the forming (34) may include extruding a sheet of the antimicrobial film. For example, the formulation may be heated to a predetermined extrusion temperature, extruded from a die as an extruded sheet, and cooled or allowed to cool to form antimicrobial film 12. The extruded sheet may be rolled into a roll, folded, or cut, to form multiple rolls or sheets.

Thus, after the forming, antimicrobial film 12 may include compositions similar to those described with reference to FIG. 1A. For example, the at least one antimicrobial agent in antimicrobial film 12 includes a combination of the silver-based antimicrobial agent and a polybiguanide or salt thereof. In some examples, the at least one antimicrobial agent includes a combination of silver sulfadiazine and chlorhexidine diacetate. Further, following the forming (34), antimicrobial film 12 defines first and second major surfaces 18 or 20. First and second major surfaces 18 or 20 may optionally be treated after forming (34) antimicrobial film 12.

For example, one or both of major surfaces 18 or 20 may be treated with a surface agent or a surface treatment. In some examples, the example technique of FIG. 5 optionally includes applying an adhesive composition to a major surface defined by antimicrobial film 12 (36). For example, the adhesive composition may be applied by brushing, spraying, dripping, padding, extruding or drawing the composition along one or both of first or second major surfaces 18 or 20 of antimicrobial film 12.

In some examples, the example technique of FIG. 5 optionally includes applying release liner 22 to the contact surface defined by antimicrobial film 12 (38). For example, a web of release liner 22 may be continuously applied to a web of antimicrobial film 12 removed from a working surface. In some examples, antimicrobial film 12 may be formed on release liner 22, for example, by coating or otherwise applying the antimicrobial film to release liner 22, and curing or allowing to cure the formulation to form the antimicrobial film.

In some examples, the forming (34) of the example technique optionally includes winding the antimicrobial film about core 26 to form roll 24. In some examples, roll 24 may be removed from core 26 after the forming (34).

In some examples, the example technique of FIG. 5 includes, following the forming of antimicrobial film 12, applying antimicrobial film 12 on target surface 16 to provide an antimicrobial effect to target surface 16 (40). The applying (40) may including aligning antimicrobial film 12 with target surface 16 and bringing the contact surface of antimicrobial film 12 into contact with target surface 16. An adhering pressure may optionally be applied along antimicrobial film 12, for example, by sliding a draw-down applicator bar or otherwise by pressing uniformly along antimicrobial film 12, to promote uniform adhesion of antimicrobial film 12 to target surface. In some examples, the applying (40) may include wetting one or both of antimicrobial film 12 or target surface 16 with a compatible wetting agent, for example, water, to promote adhesion.

As described with reference to FIG. 1A, in some examples, antimicrobial film 12 includes at least one water permeable polymer and uniformly dispersed particles therein of at least one antimicrobial agent. The particles and any agglomerations of the antimicrobial agent have an average size of no greater than 50 microns. Antimicrobial film 12 defines a contact surface configured to contact target surface 16.

In some examples, antimicrobial films according to the disclosure demonstrate broad spectrum efficacy against gram positive bacteria, gram negative bacteria, and yeasts. Thus, example techniques according to the disclosure may be used to form and apply antimicrobial films to target surfaces, to provide target surfaces with antimicrobial effects.

While examples of antimicrobial films have been described, in some examples, example articles may include antimicrobial fibers spun from example antimicrobial formulations described herein. In some examples, the antimicrobial fibers may include woven or nonwoven fibers. In some examples, example articles may include a fabric, a mat, a net, or a pad, including example antimicrobial fibers, and optionally, other fibers, for example, carrier fibers. In some examples, the antimicrobial fibers may be used in the form of sutures, e.g., removable (e.g., after about seven days) or biodegradable sutures used to close a wound or surgical incision. A biodegradable suture may include the use of a biodegradable polyurethane or other polymer-based materials.

Example articles may include articles formed entirely from or partially from nonwoven and/or woven fibers, where the fibers are spun or otherwise made from example antimicrobial formulations. The woven and/or nonwoven fibers may be in the form of a woven and/or nonwoven fabric or other material including a plurality of woven and/or nonwoven fibers. In some examples, woven or nonwoven articles may include gauze, hernia mesh, gloves, socks (e.g., to be worn over human feet), scrubs or other clothing (e.g., to be worn by medical personal in an operating room setting such as pants, shirts, surgical masks, shoe covers, hat/hairnets or other head/hair covering articles, and the like), or sterile field drape. In some examples, article may be a pouch, pocket or other enclosure for components (e.g., medical device packaging or other product packaging), such as a pouch or pocket formed of a woven or nonwoven fabric pouch or pocket of an article of clothing or an apparatus. The antimicrobial articles including antimicrobial fibers may be used in a hospital or clinical setting.

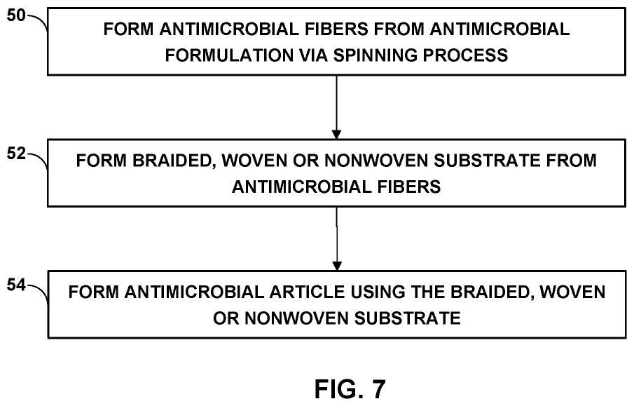

FIG. 7 is a flow diagram illustrating an example technique for forming an article including antimicrobial fibers. For ease of illustrating, the example technique of FIG. 7 includes the formation of fibers using a fiber spinning process. Other example processes for forming a fiber can be used in other examples.

As shown in FIG. 7, antimicrobial fibers may be formed from an example antimicrobial formulation via a spinning process (50). The antimicrobial formulation may be one of the example formulations described in this disclosure. Example formulations that include THF may be particularly suited for spinning because the THF evaporates from the formulation relatively quickly. Depending on the spinning process, the antimicrobial formulation may be in a fluid state prior to the spinning process. In some examples, the antimicrobial formulation may be melted, chemically treated, and/or a solvent may be added to generate a formulation in the liquid state (or otherwise provide an antimicrobial formulation with properties required for the spinning process). Suitable solvents include polar and non-polar solvents. The spinning process may include forcing or otherwise passing the liquid state antimicrobial formulation through a spinneret, then cooled to a rubbery state, and then to solidified state. For example, formulation that include solvents, the solvent may be removed after the formulation is forced or otherwise passed through the spinneret.

Example spinning processes that may be used include wet spinning, dry spinning, melt spinning, gel spinning, electrospinning, or drawing. In some examples, wet spinning is a process is used for polymers that need to be dissolved in a solvent to be spun. The spinneret is submerged in a chemical bath that causes the fiber to precipitate, and then solidify, as it emerges. The process gets its name from this “wet” bath. A variant of wet spinning is dry jet-wet spinning, where the solution is extruded into air and drawn, and then submerged into a liquid bath.

In some examples, dry spinning includes extruding a composition with a fiber-form material and solvent through a spinneret. A stream of hot air impinges on the jets of solution emerging from the spinneret, the solvent evaporates, and solid filaments are left behind.

In some examples, melt spinning is a process used for polymers that can be melted, where the melted polymer solidifies by cooling after being extruded from the spinneret.

In some examples, an extrusion spinning process includes pellets or granules of solid polymer formulation being fed into an extruder. The pellets are compressed, heated and melted by an extrusion screw, then fed to a spinning pump and into the spinneret, and then cooled upon exiting the spinneret. Direct spinning may avoid the stage of solid polymer pellets or granules. The melted polymer is produced from the antimicrobial formulation, and then pumped to a spinning mill.

In some examples, gel spinning, also known as dry-wet spinning, may be used to obtain high strength or other special properties in the fibers. The polymer is in a “gel” state, (e.g., only partially liquid), which keeps the polymer chains somewhat bound together. These bonds produce strong inter-chain forces in the fiber, which increase its tensile strength. The polymer chains within the fibers also have a large degree of orientation, which increases strength. The fibers are first air dried, then cooled further in a liquid bath.

Electrospinning may use an electrical charge to draw relatively fine (e.g., on the micro or nano scale) fibers from a liquid—either a polymer solution or a polymer melt. Electrospinning may share characteristics of both electrospraying and conventional solution dry spinning of fibers. The process does not require the use of coagulation chemistry or high temperatures to produce solid threads from solution and may be particularly suited to the production of fibers using large and complex molecules.

Drawing is a process that may be used to increase the strength and/or orientation of fibers. The drawing may be performed while the polymer is still solidifying or after it has completely cooled.

The spinning process may be configured to form antimicrobial fibers with desired properties, such as, desired tensile, elongation, and/or denier properties, which may depend on the desired application of the fibers. For example, if the antimicrobial fibers are used to form a suture thread, then the spinning process may be selected such that the resulting fibers have the desired tensile strength properties for a suture thread, as well as the desired biocompatibility and absorption properties. As another example, if then antimicrobial fibers are used to form a fabric, then the spinning process may be selected such that the resulting fibers have the desired tensile strength and elongation properties that enable the fibers to be manipulated (e.g., woven, etc.) to form the fabric. In any of these examples, the fibers may be formed using the spinning process to have any desired longitudinal length, diameter, and cross-section, which may depend upon the application for the fibers.

In some examples, the substrate including the antimicrobial fibers may include other types of materials (e.g., polyglycolic acid (PGA), polylactic acid (PLA), polylactide-glycolide copolymer (PLGA or PLA-PGA), a copolymer including poly(caprolactone) PCL, that may be copolymerized with PLA or PGA or both, and biodegradable polyurethane. Such material may be incorporated during the spinning process (e.g., the other material may be spun with the antimicrobial formulation) and/or may be incorporated later, e.g., by braiding or weaving the other materials with the antimicrobial fibers.

Once the antimicrobial fibers have been formed via spinning (50), the fibers may be used to form a braided, woven or nonwoven substrate using any suitable technique (52). The resulting braided, woven or nonwoven substrate may include the antimicrobial fibers. In some examples, the fibers are used in a state other than being braided, woven or nonwoven. The braided, woven or nonwoven substrate may then be used to form an antimicrobial article, including one or more of the antimicrobial articles described herein (54). The resulting antimicrobial article may include a plurality of antimicrobial fibers.

### Examples

The following examples are intended to further illustrate certain examples of the disclosure and are not limiting in nature. Those skilled in the art will recognize, or be able to ascertain, using no more than routine experimentation, numerous equivalents to the specific substances and procedures described herein.

In a first test, a series of antimicrobial formulations were prepared by initially preparing an approximate 12 wt % polymer solution. This was accomplished by combining a thermoplastic polyurethane elastomer polymer (Pellethane 2363-80A thermoplastic polyurethane polymer available from Lubrizol, Wickliffe, Ohio) with Tetrahydrofuran (THF) in a polymer reactor. Four different thermoplastic polyurethane elastomer polymers were used which had weight average molecular weights of about 82,400; 89,700; 90,400; and 105,900 Daltons, which were determined by gel permeation chromatography (GPC) equipped with a refractive index detector coupled with a light scattering detector for absolute molecular weight measurement (Mw). These polymer solutions had Brookfield viscosity values of 1167, 1686, 1533, and 3965 cP, respectively, as determined from a Brookfield viscometer with approximately 12.5 wt % solids in THF. The polymer reactor was configured with a reflux condenser, stirring mechanism and nitrogen gas inlet to provide a constant nitrogen blanket in the reactor. THF was added to the reactor and the polyurethane polymer was added to a level of about 12.3 weight percent solids, and the mixture was heated with mixing at 45 degrees Celsius (° C.) to 55° C. for 16 hours, then cooled to ambient temperature to form the solution containing the polymer. The percent solids of the polyurethane polymer solution was measured gravimetrically, by placing a sample on an aluminum weighing dish in a lab oven at 110° C. for 60 minutes.

A mixture containing the polymer solution utilizing the polyurethane having a molecular weight of 89,700 Daltons and a silver-based antimicrobial agent was then prepared by combining 181.22 grams of the polyurethane polymer/THF solution with 91.78 grams of THF and with 2.81 grams of silver sulfadiazine (AgSD) in a one (1) quart sealed glass jar milling vessel together with milling media, i.e., zirconia grinding media. This mixture was then milled for 24 hours in the sealed glass jar milling vessel on a roll mill using 555 grams (114 media pieces) of yttria-stabilized zirconia grinding media ⅜ inch cylinder shape (available from Inframat Advanced Materials, Manchester, Conn.,). The milling rate was set to about 50 rpm for this and subsequent milling.

A mixture of chlorhexidine acetate (CHA) (available from Medichem, S.A., Barcelona, Spain) was separately prepared by combining 4.64 grams of CHA with 9.30 grams of methanol with mixing until complete dissolution was achieved. Then 12.4 grams of THF was slowly added to the CHA/methanol solution with mixing. The CHA/methanol/THF solution was then added to the milling vessel containing the polyurethane/THF/AgSD mixture, with mixing, in increments of equal volume at approximately every 1 hour interval for a total 6 hour time period. This mixture was then milled for 24 hours.

Additional processing aids and solvents can be added to the milled mixture. For this example, approximately 98.6 grams of n-propanol was added in increments of equal volume over 2 hours while milling, and the mixture was milled for an additional 3 hours to provide an antimicrobial formulation. Milling was conducted throughout the n-propanol addition. n-propanol was added in 2 increments of equal volume, then milled for an additional 3 hours. For this example, n-propanol was the let-back solvent used to dilute the formulation to reduce the overall amount of the THF, and to provide improved flow/leveling of the coating on drying. This formulation had the following weight percentages:

TABLE 1
Example Antimicrobial Formulation

| Ingredient | Approximate Weight % |
|---|---|
| Polyurethane polymer | 8.41 |
| AgSD | 0.70 |
| CHA | 1.16 |
| THF | 62.81 |
| Methanol | 2.32 |
| n-propanol | 24.60 |
| Total | 100 |

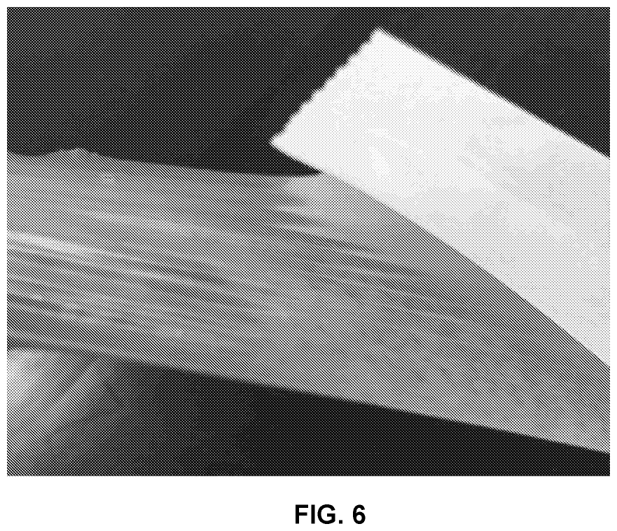

The antimicrobial formulation of TABLE 1 was used to prepare an example antimicrobial film. The antimicrobial film was prepared by casting the antimicrobial formulation using a coating draw-down applicator bar on a releasable thermoplastic olefin (TPO) substrate at about 10 mils (about 0.5 mm) wet film thickness using and also at 20 mils (about 1 mm) wet film thickness, based on the draw down applicator. The drawn down applicator had a 20 mil and a 40 mil designation for the different coating thicknesses, although it was known to actually provide approximately half of the designated thicknesses as the wet film during the actual application process. The films were dried at ambient temperature for approximately 1 hour, then subsequently dried at 60° C. for 48 hours. The films were readily removed from the TPO substrate, and maintained their integrity, shape and size. The films were determined to be approximately 25 microns and 50 microns in thickness by measurement on a Scanning Electron Microscope. FIG. 6 is a photograph illustrating the antimicrobial film.

A technique for determining release rate is described. Films prepared according to this example can be tested for the release rates of the antimicrobial agents in phosphate buffered saline (PBS) solution. The release rates can be determined by taking samples of PBS solution from a container holding cut samples of the films. The cut samples can be combined with PBS solution in a sample container mounted on a shaker which set to 37° C. and 120 rpm. The cut samples can then be removed from the container and placed in new sample containers with PBS solutions first at the 4 hour mark, then at every 24 hours thereafter. The PBS solutions can then be analyzed for antimicrobial content. Chlorhexidine can be analyzed by high Performance Liquid Chromatography (HPLC) and silver concentration can be analyzed by Inductively coupled plasma mass spectrometry (ICP-MS).

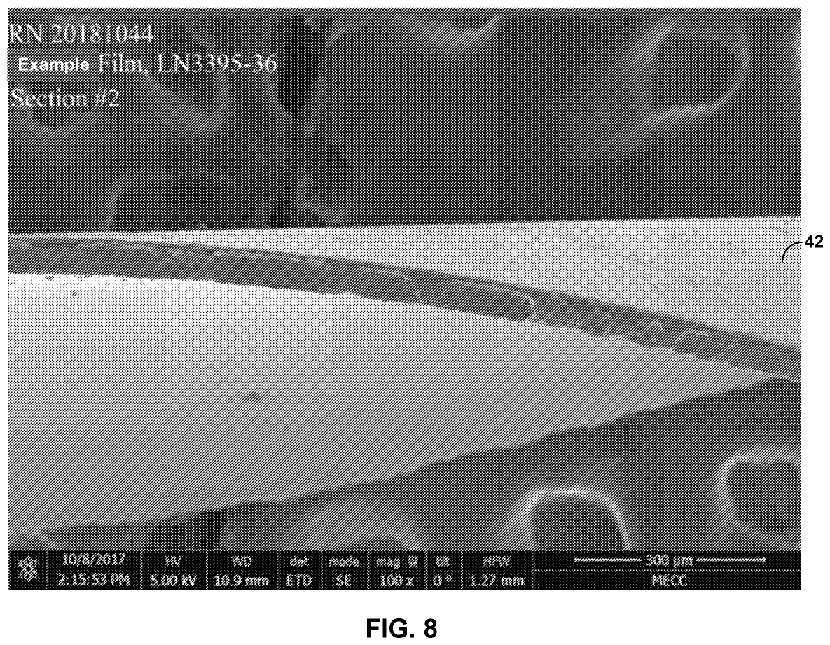

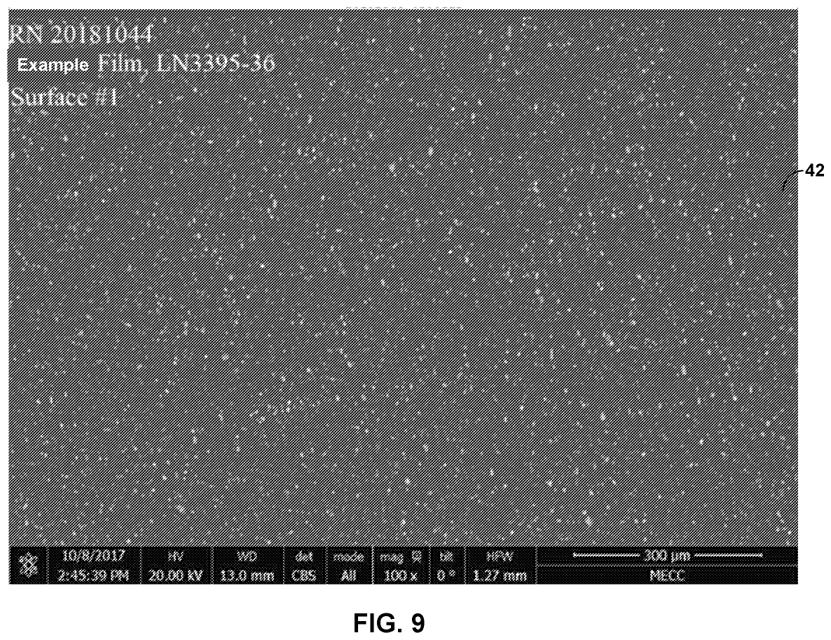

In another test, an antimicrobial film was prepared on a thermoplastic olefin (TPO) substrate using the following process. The antimicrobial film was prepared by casting the antimicrobial formulation of TABLE 1 using a coating draw-down applicator bar on a releasable TPO substrate at 40 mil wet film thickness based on the applicator bar. The film was dried at ambient temperature for approximately 24 hours, then subsequently dried at 60° C. for approximately 2 days. After drying, the film was readily removed from the TPO substrate, and maintained its integrity, shape and size. The film was determined to have an average thickness of 62 microns by measurement on a Scanning Electron Microscope (SEM). FIG. 8 is an SEM image of the antimicrobial film 42. FIG. 9 is another SEM image showing the surface of the antimicrobial film 42, with the bright white spots on the surface being the silver particles.

In another test, the antimicrobial efficacy of the prepared antimicrobial film was evaluated using an in vitro seven day test method with Staphylococcus aureus as the microorganism. Staphylococcus aureus was chosen as the microorganism for testing, as it is one of the most common microorganisms in some clinical environments. A film sample was sterilized by ethylene oxide (EtO) sterilization process, and then three pieces were cut into dimensions 4.5 cm by 0.014 cm each under aseptic conditions. Four milliliters (mL) of sterile phosphate-buffered saline (PBS) was pipetted into each of three separate sterile 15 mL centrifuge tubes. The three films were then placed individually into the three separate 15 mL centrifuge tubes. The samples were then placed into an incubator/shaker at 37° C. and 50 rpm, and maintained at these conditions for days. The centrifuge tubes were placed in the horizontal position in the incubator/shaker for the seven day aging. At the conclusion of the seven day aging, the samples were removed and inoculated with Staphylococcus aureus and returned to the incubator/shaker and maintained at 37° C. and 50 rpm for 24 hours. The antimicrobial efficacy was evaluated after a 24 hour time interval post-inoculation. The method of evaluation of antimicrobial efficacy was evaluated by log reduction of colonies from a control sample and the film test samples. It was determined that great than (>) 4 log reduction was obtained for Staphylococcus aureus, showing total kill of the Staphylococcus aureus.

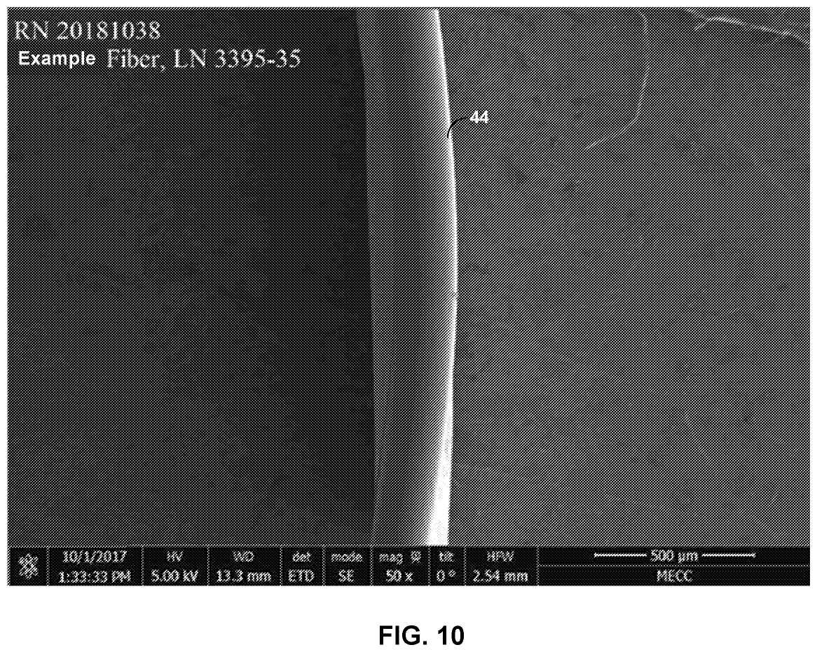

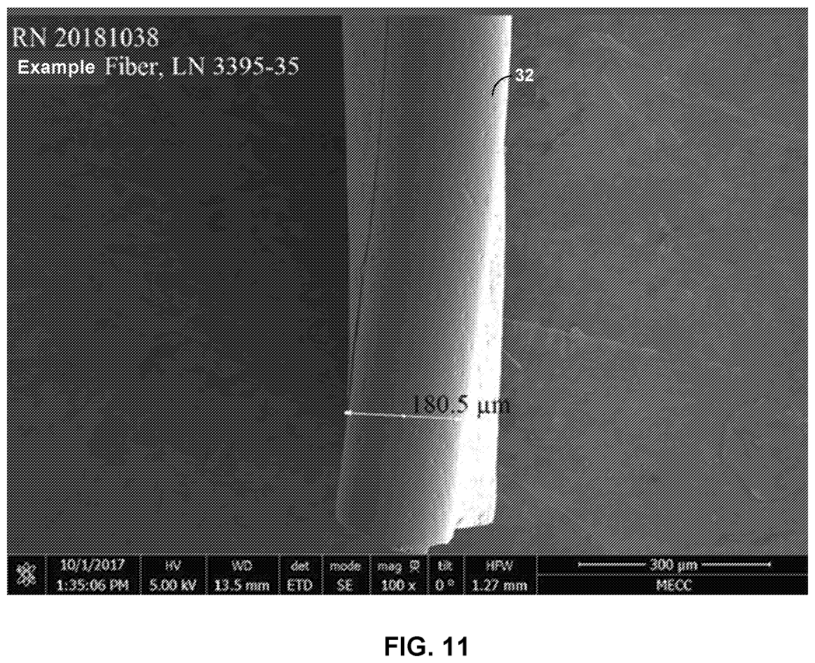

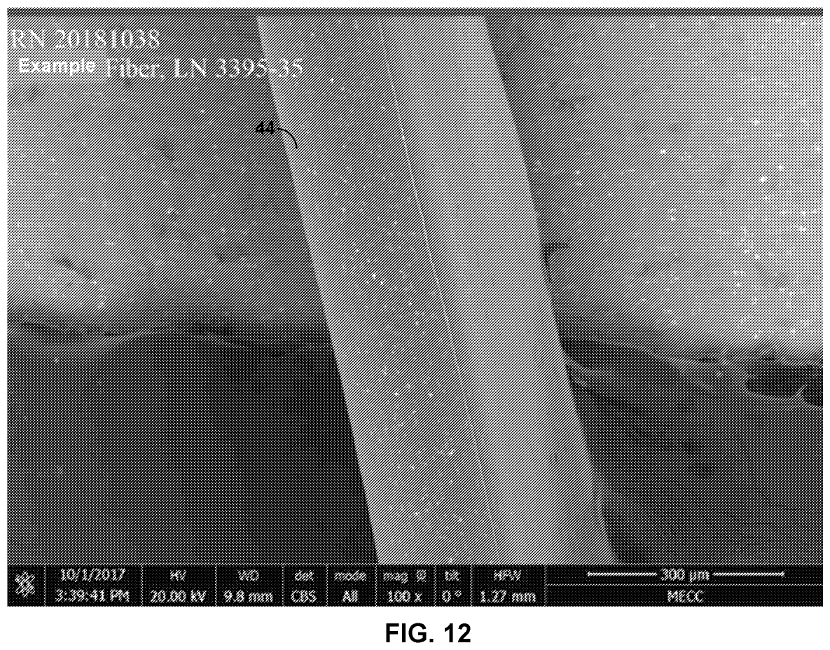

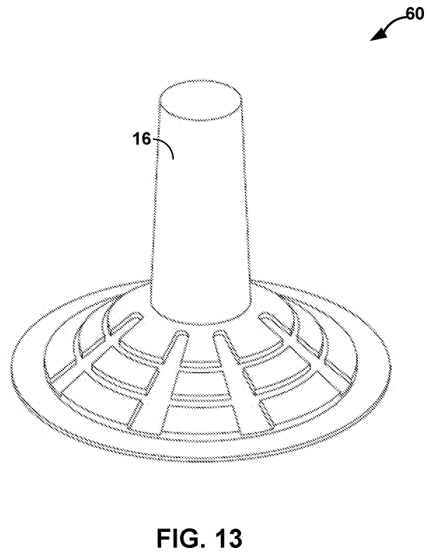

In another test, an antimicrobial fiber was prepared by first placing approximately 10 mL of coating formulation having a composition as shown in TABLE 1 above in a 20 mL glass vial. A second 20 mL glass vial was used to rapidly transfer the coating solution between the two vials, to allow for solvent evaporation and increased coating formulation viscosity. After approximately 10 minutes of the rapid transfer of the formulation between vials, an aliquot of formulation was placed at the end of a plastic pipette. Next, a metal spatula was attached to the aliquot of the coating formulation and pulled in a linear manner to create the fiber. The fiber was allowed to air dry suspended in a glass beaker at ambient temperature for 6 days, then sent for imaging by SEM. FIGS. 10 and 11 are SEM images of the fiber 44. FIG. 11 includes a dimensional measurement of the fiber 44 indicating that the oval shaped fiber had a diameter of 180.5 microns. FIG. 12 is another SEM image showing the surface of the antimicrobial fiber 44, with the bright white spots on the surface being the silver particles. Since the antimicrobial fiber surface was curved, the silver particles are shown as bright white spots in the SEM image of FIG. 12 only on the part of the fiber surface that was facing the SEM beam.

Various examples have been described. These and other examples are within the scope of the following claims.

What is claimed is:

1. An article comprising an antimicrobial film, wherein the antimicrobial film comprises at least one water permeable polymer comprising uniformly dispersed particles of at least one antimicrobial agent, wherein the particles and any agglomerations of the at least one antimicrobial agent have an average size of no greater than 50 microns, wherein the antimicrobial film defines a contact surface configured to contact a target surface defined by a second article to provide an antimicrobial effect to the target surface.

2. The article of claim 1, wherein the contact surface comprises one or more of a tacky surface, an adhesive surface, or an electrostatic surface.

3. The article of claim 1, further comprising a release liner, wherein the contact surface is in releasable contact with the release liner.

4. The article of claim 1, wherein the average size is no greater than 20 microns.

5. The article of claim 1, wherein the at least one water permeable polymer encapsulates the at least one antimicrobial agent.

6. The article of claim 1, wherein the at least one water permeable polymer includes at least one of a polyurethane or a thermoplastic polyurethane elastomer.

7. The article of claim 1, wherein the at least one water permeable polymer includes at least one of a polyurethane, thermoplastic polyurethane elastomer, polyester, polylactic acid, polyglycolic acid, polytetramethylene glycol, polyacrylamide, polyacrylic acid, polyacrylate, poly(2-hydroxyethyl methacrylate), polyethylene-imine, poly-sulfonate, or copolymers thereof.

8. The article of claim 1, wherein the at least one water permeable polymer has a weight average molecular weight of from about 70,000 to about 120,000 Daltons.

9. The article of claim 1, wherein the at least one antimicrobial agent comprises silver sulfadiazine, and wherein the antimicrobial film has a release profile such that at least 0.50 micrograms per centimeter (μg/cm) of silver is continuously released after 72 hours.

10. The article of claim 1, wherein the at least one antimicrobial agent comprises chlorhexidine diacetate, and wherein the antimicrobial film has a release profile such that at least 10 μg/cm of chlorhexidine diacetate is continuously released after 72 hours.

11. The article of claim 1, wherein the at least one antimicrobial agent comprises a silver-based salt and a polybiguanide salt.

12. The article of claim 11, wherein the silver-based salt is silver sulfadiazine, and the polybiguanide salt is chlorhexidine diacetate.

13. The article of claim 12, wherein the antimicrobial film comprises from about 2 weight percent (wt. %) to about 10 wt. % of silver sulfadiazine, at least 9 wt. % of chlorhexidine diacetate, and about 70 wt. % to about 90 wt. % of the at least one water permeable polymer.

14. The article of claim 1, wherein the antimicrobial film defines a thickness of about 5 microns and about 1000 microns.

15. The article of claim 1, further comprising the second article defining the target surface, wherein the contact surface of the antimicrobial film is in contact with the target surface, wherein the second article comprises at least one of a surgical tray, an operating table, an operating console, an implantable device, a medical device, a medical tool, a catheter, a wound dressing, a securement dressing a light emitting device, door, faucet, light switch, or keypad.

16. A method comprising:
milling at least one water permeable polymer which is dissolved in a liquid medium with at least one antimicrobial agent which is insoluble in the liquid medium to form an antimicrobial formulation in which the at least one water permeable polymer encapsulates the at least one antimicrobial agent;
adding a primary C₁₋₆ alcohol to the antimicrobial formulation, wherein the at least one antimicrobial agent includes a silver-based antimicrobial agent, and wherein the at least one water permeable polymer includes at least one of a polyurethane or a thermoplastic polyurethane elastomer; and
forming an antimicrobial film from the antimicrobial formulation, wherein, following the forming of the antimicrobial film, the antimicrobial film defines a contact surface configured to contact a target surface defined by a separate article to provide an antimicrobial effect to the target surface.

17. The method of claim 16, wherein the antimicrobial formulation comprises uniformly dispersed particles of the at least one antimicrobial agent, wherein the particles and any agglomerations of the at least one antimicrobial agent have an average size of no greater than 50 microns.

18. An article comprising a plurality of antimicrobial fibers, wherein the plurality of antimicrobial fibers comprise at least one water permeable polymer comprising uniformly dispersed particles of at least one antimicrobial agent, wherein the particles and any agglomerations of the at least one antimicrobial agent have an average size of no greater than 50 microns.

19. The article of claim 18, wherein the plurality of fibers form a braided, woven, or nonwoven substrate.

20. The article of claim 14, wherein the article comprises at least one of a suture, a wound dressing, gauze, a hernia mesh, a glove, a sock, pants, a shirt, a surgical mask, a shoe cover, a hat, a hairnet, or a sterile field drape.
